(19) United States
(12) Patent Application Publication
(10) Pub. No.: US 2009/0277031 A1
(43) Pub. Date: Nov. 12, 2009

(54) CONSTRUCTION LAYOUT METHOD AND TEMPLATE

(75) Inventor: Tracy D. Stocking, Salt Lake City, UT (US)

Correspondence Address: Workman Nydegger;1000 Eagle Gate Tower, 60 East South Temple, Salt Lake City, UT, 84111, US

(73) Assignee: FULL SCALE LAYOUTS, INC., Salt Lake City, UT (US)

(21) Appl. No.: 12/435,833

(22) Filed: May 5, 2009

Related U.S. Application Data
(60) Provisional application No. 61/050,867, filed on May 6, 2008.

(51) Int. Cl. G01B 3/00

(52) U.S. Cl. 33/562

(57) ABSTRACT

A method of building construction layout utilizing full-scale plans or templates. Plans are printed full-scale on an appropriate media, and applied to the building sub-floor prior to the remainder of construction. Construction elements such as walls are placed directly on the media. Options range from reproducing plans as originally drawn to integrating multiple plans into a single file or image. The plans remain in place, effectively a full-size template, until all related work is complete. When no longer needed the media is removed. Full scale plans do not replace the Contract Construction Documents—but are a full-scale reproduction of selected portions of the Contract Documents.

### CROSS-REFERENCE TO RELATED APPLICATIONS

This application claims the benefit of U.S. Provisional Application No. 61/050,867, filed May 6, 2008, which is incorporated herein by reference in its entirety.

### BACKGROUND OF THE INVENTION

1. The Field of the Invention

The present invention relates to the field of methods of building construction layout. More specifically, the invention relates to a method and template for providing full-scale plans as a guide to construction and installation of building components.

2. The Relevant Technology

The current construction layout method has changed little in a hundred years. After the sub-floor has been constructed (of whatever material is specified for a project) workers read and translate the information from scaled construction drawings. The workers mark key points on the floor by hand, then mark walls and openings with chalk lines. Throughout the course of construction the various trades (such as electricians, plumbers, HVAC installers, cabinet-makers, ceiling installers, etc.) perform their own layout, again by hand—often duplicating, or over-lapping previous efforts.

The highest cost in construction is labor. Any reduction in labor is valuable. To try to control costs, contractors increasingly turn to less-skilled workers. These workers may have limited construction, communication, analytical and technical skills.

Current layout methods are time consuming, labor-intensive, costly, difficult for an un-trained work-force, and prone to error.

Accordingly, it would be beneficial in the art to have a method and system of building construction layout that address some or all of the foregoing shortcomings.

The method and system of the current application will reduce errors, save construction time, and improve accuracy.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1A is a flow chart of one embodiment of a method for providing full-scale plans, or templates, as a guide to construction, and installation of building components;

FIG. 1 is a perspective view of a finished sub-floor;

FIG. 2 is a perspective view of the sub-floor of FIG. 1 with a construction template partially installed thereon;

FIG. 3 is a perspective view of the sub-floor of FIG. 1 with the construction template completely installed thereon;

FIG. 4 is a perspective view of the sub-floor of FIG. 1 with the construction template completely installed thereon and wall construction partially completed;

FIG. 5 is a perspective view of a portion of the sub-floor of FIG. 1 showing a portion of the construction template being cut and peeled away;

FIG. 6 is a perspective view showing overlapping construction templates;

FIG. 7 is a perspective view of a portion of the sub floor with the construction template overhanging the side of the sub floor;

FIG. 8 shows a portion of a floor plan as commonly displayed in construction documents;

FIG. 9 shows a full scale template of the portion of the floor plan shown in FIG. 8; and

FIG. 10 shows a portion of the installed construction template corresponding to the portion of the floor plans shown in FIGS. 8 and 9.

### DETAILED DESCRIPTION OF THE PREFERRED EMBODIMENTS

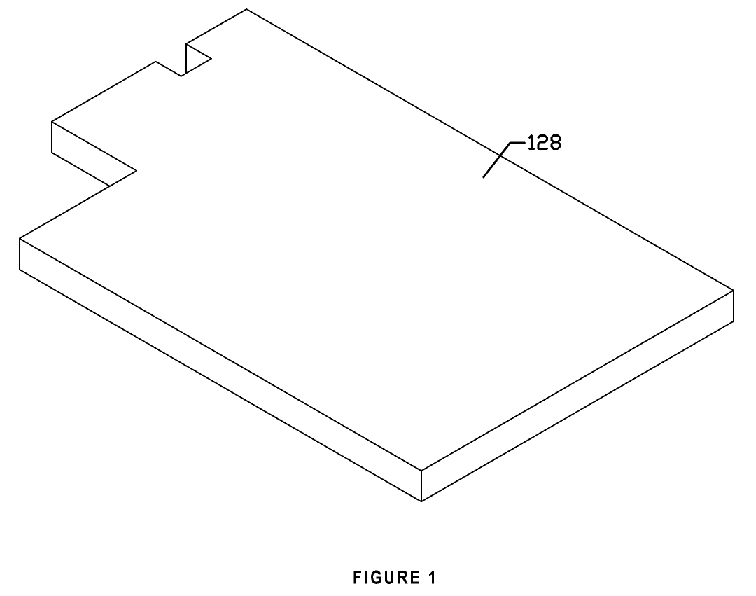

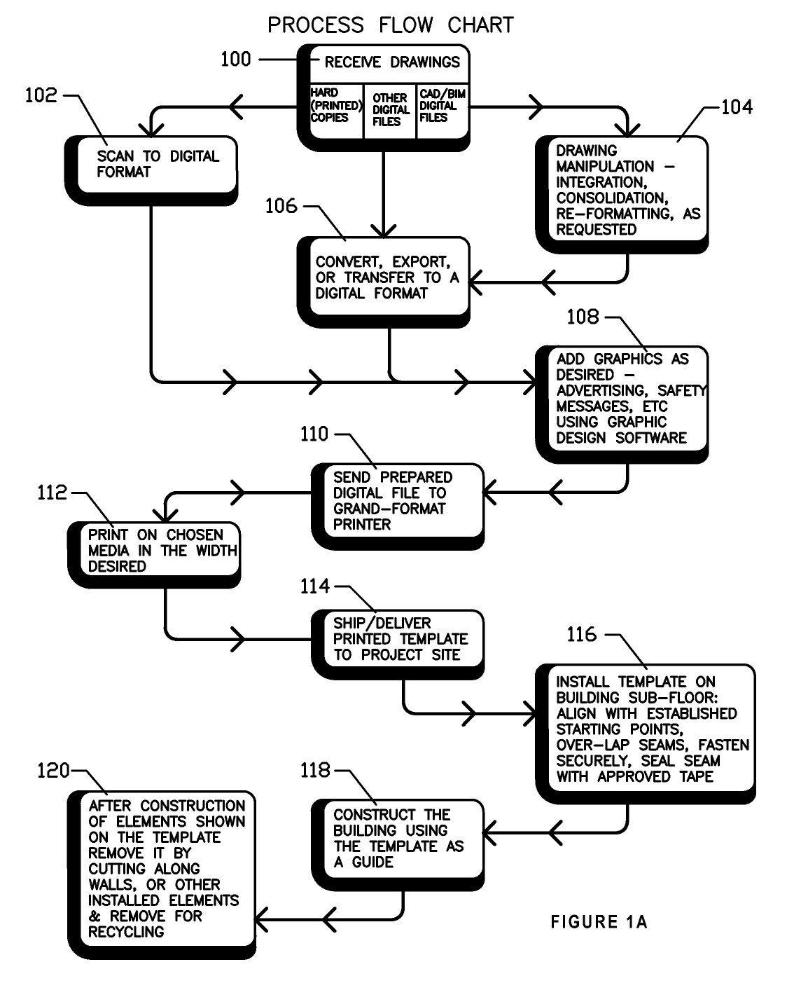

Depicted in FIG. 1A is a flow chart showing one embodiment incorporating features of the present invention. In general, construction documents are received in step 100 that include various drawing images and other information. The drawing files that are not already in digital format are scanned into a digital format in step 102. In step 104, the drawings are manipulated as required. In step 106, the drawing files, including those that have been scanned and/or manipulated are converted, exported, or transferred, as necessary, to a digital format, thereby creating one or more formatted digital files.

Once the file is in the desired digital format, any desired additional graphics are then added to the file in step 108. The digital file is then formatted for final processing in step 110 and sent to the printer in step 112, where the template is processed and printed in full scale on the chosen media and in the width desired based on the information included in the finalized file. Once printed, the full scale template is delivered to the project site in step 114, and installed on the finished sub floor in step 116. At the project site, the building is then constructed using the full scale template as a guide in step 118. After construction, the template or parts thereof can be removed in step 120. These steps will now be discussed in greater detail.

Step 100. Construction documents are received that include various drawing images and other information. These documents are in digital or non-digital format or a combination of each. For example, the documents can be hand-drawn plans, Computer Aided Design (CAD) drawings or Building Information Modeling (BIM) files typically prepared by Architects, Designers, Drafters, Engineers, etc. Digitized electronic images of hand-drawn plans can be utilized as well. Other types of documents can also be used.

The types of construction information included in these documents may include, but not be limited to, the following:
Architectural/Building Floor Plans & Information
   Room Names & Numbers, Walls (with construction details & ratings), Openings (Doors & Windows), Dimensions, Notation, Gridlines, Cabinets, Stairs & Railings, Specialties, Accessories, Details, Detail References, Schedule References, Specifications, Specification References, etc.
Architectural Ceiling Plans & Information
   Any and all ceiling construction elements
Structural Plans & Information
   Any and all structural elements, and/or information such as columns, posts, beams, joists, girders, trusses, rafters, purlins, connectors, bracing, shear-walls, hold-downs, etc.
Mechanical Plans & Information
   Any and all HVAC elements such as equipment, devices, grilles, control devices, ducts, pipes, flues, etc.
Electrical Plans & Information
   Any and all electrical elements and information such as devices, boxes, outlets, conduits, lighting fixtures, panels & disconnects, switch Gear and Equipment, etc.
Plumbing Plans & Information
   Any and all plumbing elements and information such as fixtures, devices, accessories, associated slab recess and block-outs, waste & vent stacks, supply drops & chases, etc.
Electronic Systems Plans & Information
   Security Systems, Fire Alarm Systems, Paging & Intercom Systems, Nurse Call & Medical Monitoring Systems
Information & Technology Systems Plans & Information
   Telecommunications devices and systems, Data devices and systems
Furnishings, Fixtures & Equipment Info
   Floor, Wall & Ceiling Finishes, Signage, Specialties, Trim & Accessories, Equipment, Furniture, Fixtures, Manufacturing Equipment & Processes, Anything that needs to be layed-out.

It is appreciated that all of the foregoing are examples of construction elements that can be printed full scale on the final full scale template or can be print as enlarged symbols on the final full scale template. For example, construction elements such as walls, doors, cabinets, columns, heat registers and others can be represented by printed lines that mark the actual full scale size and location for the corresponding structures. This is particularly useful for structures that will be built directly on the subfloor. Alternatively, elements such as outlets, light fixtures and others can be represented by printed symbols that identify where on the walls or ceilings those structures will be located.

Step 102. For documents that are received in a non-digital format, these files are converted into digital format by scanning or other process. Any commercially available scanner can be used to do this. Before scanning, the user determines what type of digital format is desired, based on the printer to be used and the printer's input requirements.

Step 104. As noted above, various types of digitized and non-digitized documents are received in the building construction process. These drawings are integrated, consolidated and/or re-formatted as necessary to create coherent, useful drawing information and to produce acceptable quality in the full scale print. For example, such manipulation may include re-scaling drawing objects and elements to a smaller scale so they will not be larger than necessary on the printed template.

Because a full scale print is ultimately generated, more blank space also becomes available on the print. This allows more information to be shown on the template that is typically not included on the floor plan. Thus, the manipulation may also include integrating or consolidating into one drawing, information normally shown on multiple separate sheets in a set of Construction or Design Drawings, such as replacing callout markings with actual information. The type of information that can be consolidated can include any of the construction elements listed previously. Also, line weights, colors, etc, of certain drawing elements, can also be changed to accommodate the full scale printout. Dimensions can also be removed, as measuring will not be needed when using the full scale template because the construction workers will simply build on top of the full scale template.

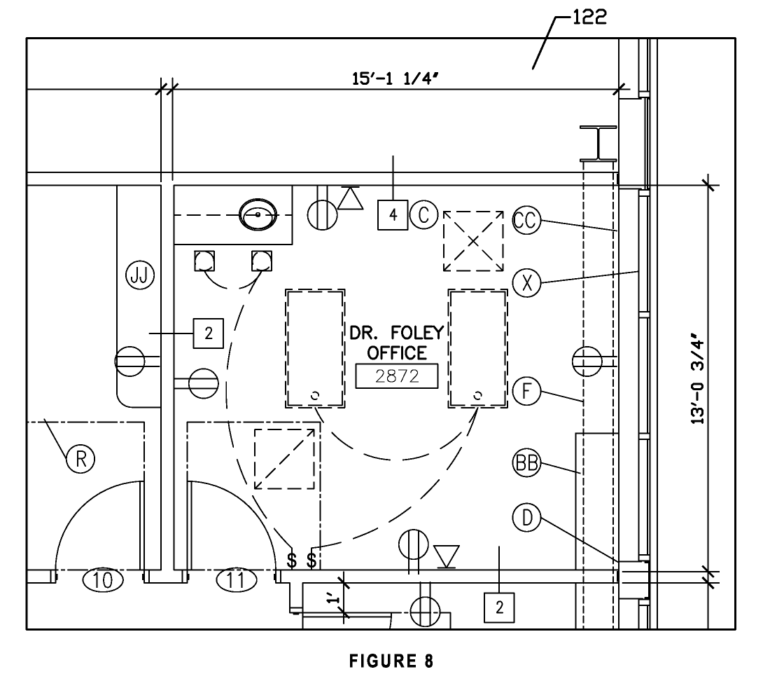

For example, FIG. 8 depicts a floor plan 122 as displayed in typical construction documents. A typical scale of such a floor plan may be ¼″=1′, or approximately 1/48. Floor plan 122 gives a construction worker a good deal of information regarding the building to be constructed. For example, floor plan 122 discloses that the room in the center of the drawing denoted as “Dr. Foley Office,” is 13′-0 ¾″ by 15′-1¼″. The room also has a door in the lower left corner that opens into the room in a counter clockwise manner.

While floor plan 122 gives the construction worker much useful information, other useful information cannot be included on the drawing because of the scale of the drawing. Markings and symbols are often used to direct the reader of the floor plan to relevant information on separate documents that cannot physically be included on the floor plan. For example, Dr. Foley's Office in floor plan 122 contains many callout letters and symbols (e.g., “2872,” “X,” etc.) to direct the reader of the floor plan (i.e. the construction worker) to information contained in other documents. The construction worker must then turn to those other documents to ascertain the information during the building process. Having to go back and forth between the different documents can be time consuming and often confusing.

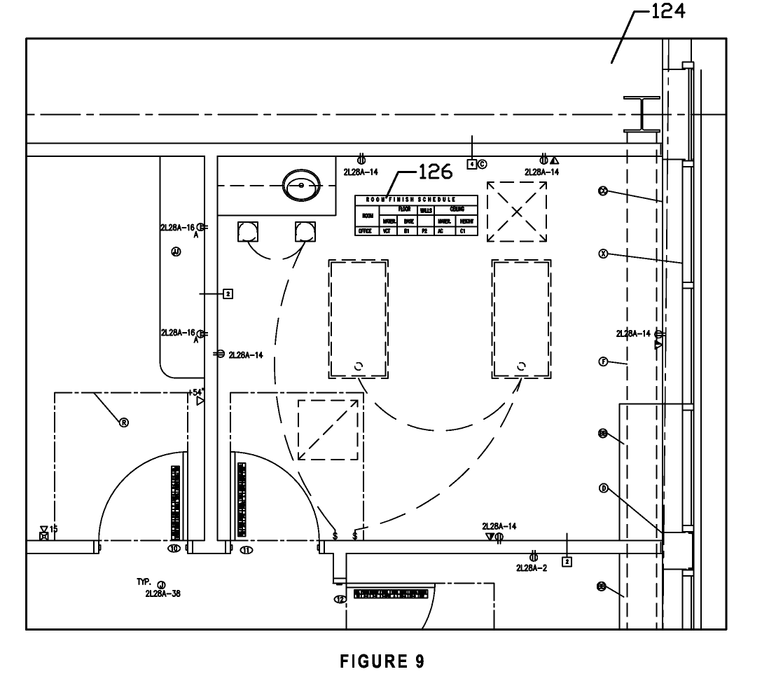

In contrast, when the final drawing is to be a full scale template, more space is available on the drawing due to the larger scale, as noted above. For example, FIG. 9 depicts an example of a portion of a full scale template 124 derived from floor plan 122. Obviously, the full-scale template 124 has been reduced in size to fit within the page size of this application. However, one can see that more information is included on the template drawing 124 than on the scaled drawing 122. For example, many of the callout letters and symbols of Dr. Foley's Office have now been replaced by the actual information. For example, callout number “2872” has been replaced by a standard Room Finish Schedule 126. Having all of the information directly on the template greatly simplifies the construction worker's job and will increase accuracy and speed of construction. Furthermore, because the final template 124 is a full scale template that will be directly built upon, no dimensions are needed to be printed thereon. Thus, all of the dimension information has been removed. Removing the dimension information simplifies the drawing. Removing the need to measure also greatly simplifies the construction worker's job and further increases accuracy and speed of construction.

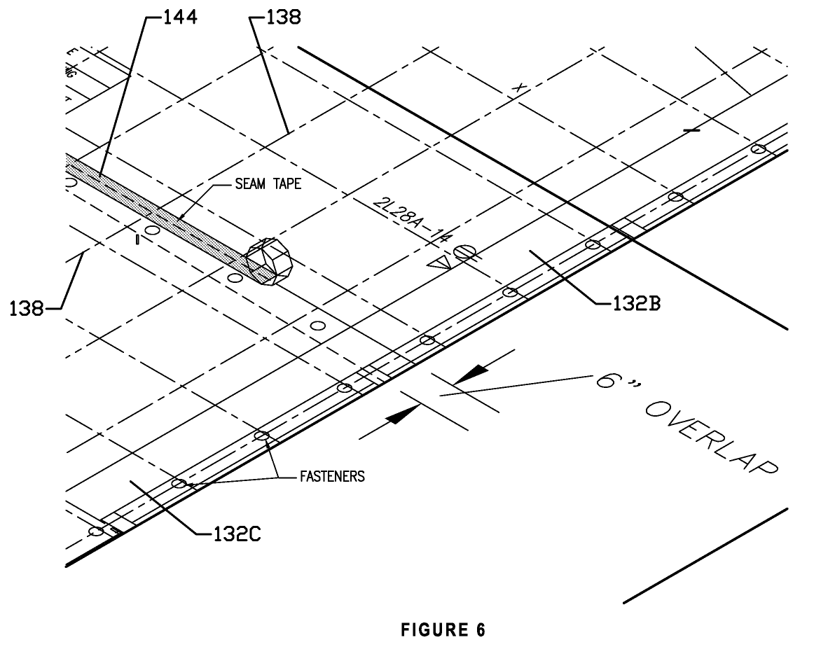

Other helpful information can also be added to the drawings as desired. For example, registration marks and grid lines can be added to the drawings (see, e.g., FIG. 6). For example, common grid dimensions, such as 16 or 24 inches can be printed on the template as background, much like graph paper. As noted below, the template is typically printed in long sheets that must be aligned during installation. Adding registration marks and grid lines will help to align the template sheets when installed.

Manipulation of the information can be done using various commercially available CAD, BIM or other graphic manipulation programs for digitized documents.

Step 106. After the files have been digitized and manipulated, the resulting files may still need to be converted or exported into a common digital format. For example, although all the files are now digitized, there may be many various types of digital files, such as, but not limited to, Bitmap, JPG, TIFF, PDF, DWF, etc. formatted files. If required, these files are converted or exported to a common digital format.

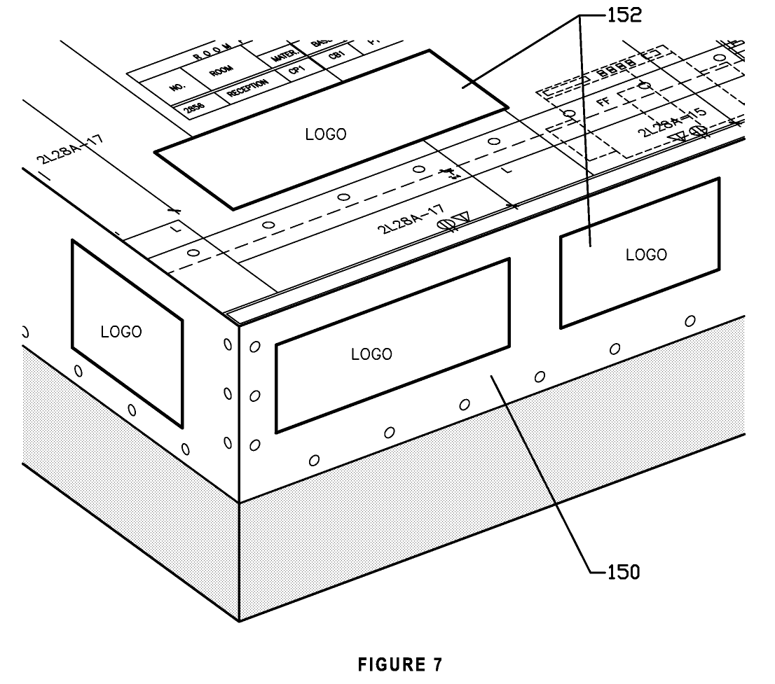

Step 108. Additional graphic images and messages, such as advertising, safety warnings, etc. can also be printed on the full scale template if desired. For example, the logo of the building contractor can be added in any blank space. The template can also be printed so as to contain an extra width that overhangs the edge of the subfloor so as to form an apron around the subfloor. For example, FIG. 7 shows an apron 150 having various exemplary logos 152 printed thereon. The images and/or messages can be derived from any digital or electronic format.

Step 110. Once all of the template files have been digitized, manipulated, and otherwise modified to include all of the information that the builder desires to have printed, the prepared digital file is then finally processed through the selected grand-format printer.

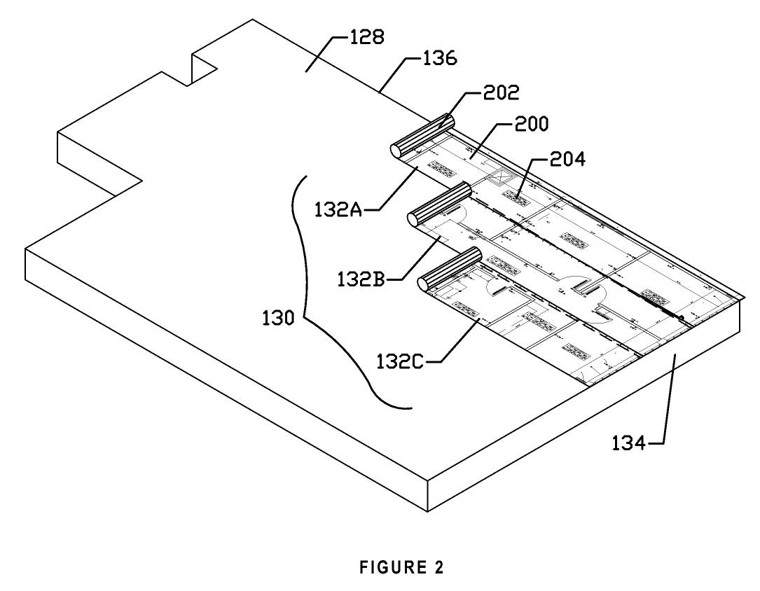

Step 112. Once finally formatted, the construction template is printed in full scale on the desired printer. As shown in FIG. 2, an exemplary construction template 130 is printed in multiple long, wide strips or sheets 132, although a single-sheet template can alternatively be generated if the printer is capable of producing such a print-out. The sheets 132 may be long enough that each sheet runs the full length of the floor. Alternatively, the sheets 132 may only be long enough to cover a portion of the full length of the floor. Printing widths of 9 feet or larger is desired, but not required. The printer can be any conventional printer that can accommodate such large width printing jobs. There are many conventional printers that can be used to print in these widths.

Each sheet 132 can also be printed so that the markings printed thereon overlap onto adjoining sheets 132. As discussed below, overlapping adjoining sheets is beneficial due to the loose tolerances that often occur in the construction industry. To allow for overlapping, the portions of the adjoining sheets that overlap have the same markings printed thereon so that when overlapped, the markings can align with each other. Markings can be printed all the way to the edges of the sheet when using printers that are capable of doing so, although this is not required. In many embodiments, a small margin can be left on one or both edges of each sheet.

In the exemplary embodiment shown in FIG. 2, the construction template 130 comprises a plurality of sheets 132, each having a first side 200 and an opposing second side 202. Markings 204 are printed on at least one of the sides of the sheet 132, corresponding to the elements shown in the template drawing 124. Each sheet 132 contains a full scale representation of a different portion of the floor plan 122 for at least a portion of the building such that adjacent sheets 132 overlap to form the floor plan 122.

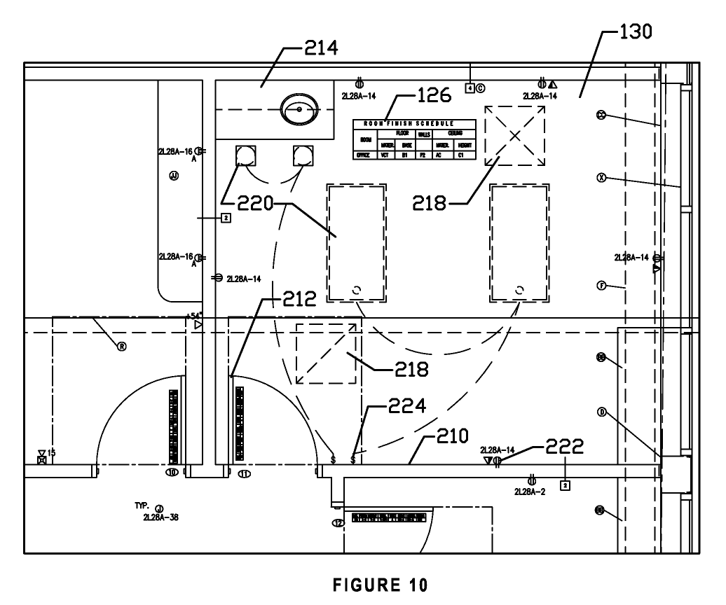

As discussed above, the markings 204 on construction template 130 comprise full scale representations of construction elements, enlarged symbols of construction elements, or enlarged text relating to construction elements. Examples of each of these types of representations are shown in the portion of the exemplary construction template shown in FIG. 10.

For example, the depicted portion of construction template 130 has at least one full scale representation of a wall 210, a door 212, and a cabinet 214 that mark the actual full scale size and location on which the corresponding structure can be built. The construction template 130 also has a full scale representation of heat registers 218 and light fixtures 220 that corresponds to the actual full scale size of the heat registers and light fixtures and the locations on the ceiling directly above the template where the heat registers and light fixtures will be located. Examples of enlarged symbols of construction shown on construction template 130 include a representation of an electrical outlet 222 and a light switch 224, positioned adjacent to the representation of the wall 210 to show the relative location of the outlet 222 and the light switch 224 along the wall 210. Examples of enlarged text relating to construction elements include the standard Room Finish Schedule 126.

It is appreciated that the representations shown on the portion of construction template 130 of FIG. 10 are exemplary only and not inclusive. As discussed above, many other types of representations can also be printed on construction template 130 corresponding to the present invention.

Acceptable media on which to print the template may include, but not be limited to paper, plastic, fabric, polymeric material, etc. that can display the printed template and that comes in the desired widths. The following characteristics of the media are desirable, but not necessarily required:
Smooth enough to accept and hold ink & for the printed image to be legible
White, or light enough, in color for the printed image to be legible
Dimensionally stable—does not stretch, shrink, or allow the printed image to distort
Durable—resistant to the wear and tear typical of a construction site for a period of time long enough for the printed image to be utilized
Slip resistant—does not promote slipping when wet or otherwise
Light weight—in the range of 10 to 20 pounds per 1000 square feet
Thin—in the range of 3 to 10 mils
Permeable to water vapor—allows transmission of water vapor to escape from the substrate in the range of 7 to 60 perms
Water resistant—does not degrade, deform, delaminate, or fail when wet;

does not absorb water
UV resistant—is UV resistant for 1 to 6 months
Available on rolls having a width of 9 ft or larger
Non flammable

Products currently manufactured for use as ‘Building Wrap” or “Air Barrier” may be appropriate. For example, the following list of manufacturers and corresponding conventional products can be used:
Covalence Coated Products—Berry Plastics (Barricade)
CS Fabric (Prime Wrap)
Dow—(Styrofoam Weathermate)
Dupont (Tyvek)
Fiberweb (Typar)
Fortifiber (Forti-Wrap)
Johns Manville (Gorrilla Wrap)
KB Building Products (Breath EZ)
National Shelter Products (Dryline Building Wrap)
PGI Fabrene (Air-Guard)
Pactive (Green Guard-Raindrop-Housewrap)
Perma R Products (Perma Wrap)
Plytex (PlyteX Building Wrap)
ProtectoWrap (Dri-Shield)
Raven Industries (Rufco Wrap)

Most of the aforementioned products are available in widths of up to 9 ft or 10 ft. It is anticipated that as technology improves wider media may also be utilized.

Products currently manufactured for use as ‘Concrete Curing” may also be appropriate. For example, the following list of manufacturers and corresponding conventional products can be used:
Fortifiber (HydrAdsorb)

It is anticipated that manufacturers may develop unique media formulations designed specifically for this application.

Step 114. Once printed, the template is delivered to the building site using conventional delivery methods. As noted above, the template is typically printed in long sheets having a width of about 9 feet or wider. These sheets are typically rolled up before being delivered to the building site. The template is not used at the building site until the sub-floor is finished. An exemplary finished sub-floor 128 is shown in FIG. 1.

Step 116. The template media, with the printed image of the selected plan, is next fastened or otherwise attached to the sub-floor. As noted above, this takes place shortly after completion of the sub-floor, and prior to any further construction. In multi-story buildings a unique plan is provided for each story.

FIGS. 2-7 depict an exemplary installation process wherein the template 130 comprises multiple sheets 132. As shown in FIG. 2, the template sheets 132 are typically laid down on the finished sub-floor side by side. The media is typically aligned with one or more points, typically building corners, previously established for installation of the building foundation. For example, template sheet 132A is first positioned on the corner 134 of the subfloor 128 and unrolled on the sub-floor so that sheet 132A follows the perimeter edge 136 of the subfloor 128. The outside edge 133 of template sheet 132A can overhang perimeter edge 136 (as shown in FIG. 2) or simply butt up against perimeter edge 136.

In one embodiment, margins of 2 ft. to 3 ft. are left un-printed on the outside edge 133 of the outer sheet 132A, except for advertising or other messages. As noted above, at the perimeter of a building or sub-floor these margins, when secured to the face of the foundation or wall below, may provide highly visible and desirable space for advertising, as discussed above (see, e.g., FIG. 7).

If utility pipes, structural columns, or other vertical elements are previously installed so as to extend through the sub-floor, the sheet 132A is cut out around those items as the sheet 132A is being installed.

The template sheet 132A is continuously adjusted during installation to ensure that the printed image thereon is correctly placed on the sub-floor 128. Several methods may be employed to ensure the template sheet 132A, and therefore the printed image, remain dimensionally true, and in proper alignment. For example, one or more of the following can be used:
Use a digital layout device to check various points
Use a laser layout device to establish reference lines, and points
Use batter boards and string lines to establish reference lines
For multiple sheet installations—align registration, or “match”, lines between sheets

It is anticipated that improved technology may be developed in the future that could also aid in accurate installation.

When assured that the template sheet 132A is properly placed and flat on the sub-floor 128, sheet 132A is fastened or adhered to the sub-floor 128. Many methods of attachment can be used.

For example, for a concrete sub-floor, the template 130 can be adhered to the concrete with one of several commercially available adhesives. In one embodiment, the adhesive is applied only under portions of the template 130 that will remain adhered to the sub-floor 128 after construction is finished. For example, this can include template portions over which walls, cabinets, etc, will be positioned. By doing this, no removal of adhesive from the concrete is required, thus alleviating any adhesive removal problems. Application of the adhesive can occur as the template 130 is being un-rolled, or after the media is placed on the sub-floor 128, through small cuts, for example. A re-positionable adhesive can also be used.

As another example, when using a wood sub-floor, the template 130 can be fastened to the sub-floor sheathing with adhesive, roofing nails, simplex nails, staples, or other fasteners with a large flat head. In one embodiment, the fasteners are used only under portions of the template 130 that will remain adhered to the sub-floor 128, similar to the adhesive used on the concrete subfloor, discussed above. As with the concrete subfloor, this will alleviate any removal problems.

When multiple sheets are required to cover a sub-floor, as in the exemplary system, each subsequent sheet 132 is installed in a similar manner, either abutting or overlapping the previous sheet. Overlapping has some advantages due to the loose tolerances that often occur in the construction industry. For example, the finished subfloor of a building often does not match the exact dimensions called for in the building plans; it is not uncommon for portions of the subfloor to be up to several inches off, or for the corners of the subfloor to not be exact right angles. By overlapping the sheets 132 adjustments can be made to compensate for these loose tolerances during the laying down of the construction template 130. For example, each adjacent sheet can overlap slightly more or slightly less than called out.

In the exemplary embodiment, each sheet overlaps the previous sheet by about 4 to 6 inches. For example, after template sheet 132A has been positioned, template sheets 132B and 132C are next unrolled and attached or adhered to the sub-floor 128 in similar manner so that sheet 132B overlaps sheet 132A and template sheet 132C overlaps template sheet 132B. As the sheets 132 are unrolled, each sheet 132 is aligned so as to be correctly positioned on sub-floor 128 before being fastened or adhered to sub-floor 128.

The sheets 132 are also aligned with adjacent sheets 132 and any seams are sealed, if desired. For example, as shown in FIG. 6, adjacent sheets 132B and 132C each have a grid pattern 138 that has been aligned between the two sheets. Other means of alignment, such as registration marks or matching lines on the sheets 132, can also be used. A seam tape 144 as is known in the art is then used to seal the seam between sheets 132B and 132C. Other sealing methods can alternatively be used, such as staples or adhesive, for example.

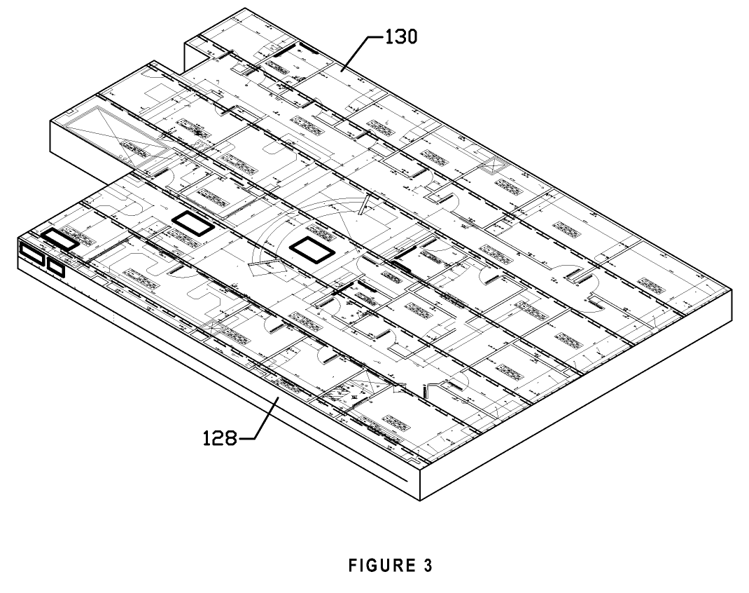

This method of positioning and aligning each sheet, attaching or adhering the sheet to the sub floor, and sealing any subsequent seams continues with each adjacent sheet 132 until the entire sub-floor 128 is covered, as shown in FIG. 3. As noted above, as an alternative to overlapping sheets, the sheets 132 can be designed to simply butt up against adjacent sheets.

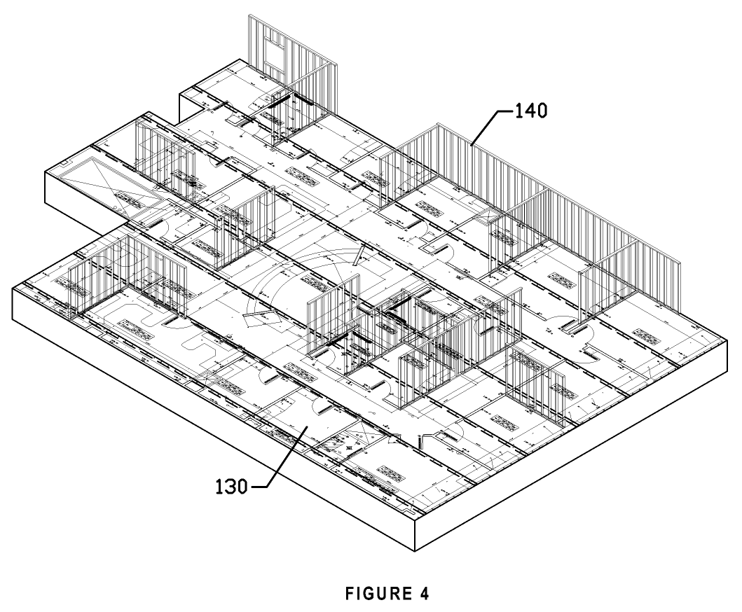

Step 118. Once the template 130 has been positioned and aligned, construction begins using the template as a guide. Walls, plumbing, cabinetry, etc. are constructed in known manner directly on the template 130 as the template remains in place on the sub-floor 128. For example, as shown in FIG. 4, various walls 140 have been framed directly on the template 130.

For the remainder of construction, or as long as it is needed, the template 130 remains on the sub-floor 128. Because all of the drawing information is included on the template 130, the construction worker can build the structure in a much shorter time and avoid potential errors by not having to consult various drawings during the construction phase. Also, because the template is full scale, the construction worker does not have to measure where the walls, etc will be. Again, this increases speed and accuracy of construction

It is not uncommon for revisions or corrections to be required after construction documents have been issued to the contractor or even after construction has begun. These corrections and revisions can be incorporated into the already printed full-scale templates in several ways:
If the change is relatively minor or small it can be made manually on the template with a permanent marker.
If a small part of the image needs to be removed, or covered-up, a quick-drying paint can be used—similar to correction fluid—to cover the desired portion. Then the new information can be made manually with a permanent marker.
If a larger area is involved in a correction, or revision, a new partial full-scale template can be printed and installed over the original template—in the same manner as the original.

### Other Incorporation Methods are Also Available.

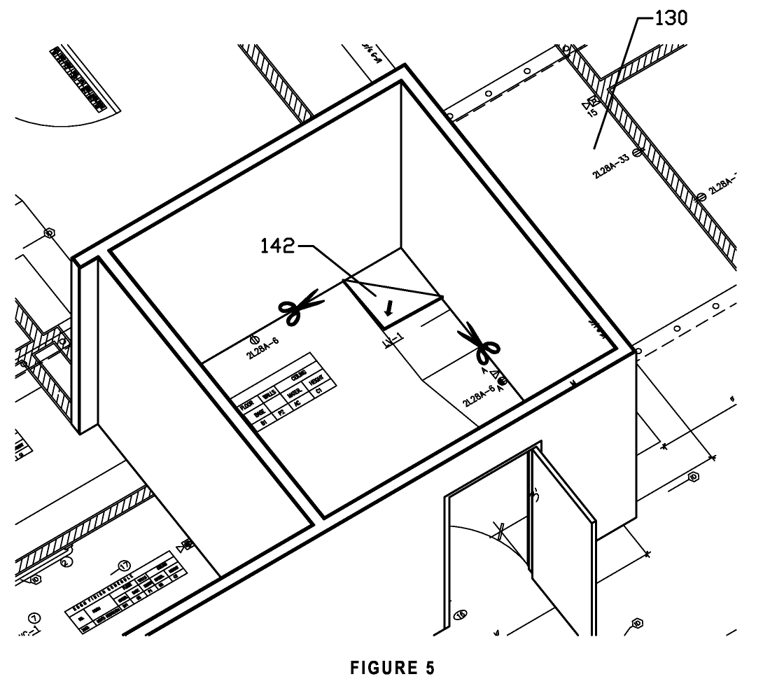

Step 120. Once the template 130 is no longer needed, template 130 can be removed and disposed. This can be accomplished at the end of the construction phase, at which time the entire template 130 is removed. Alternatively, portions of template 130 can be removed during different phases of construction, when those portions are not needed anymore. Generally, the removable portions of the template 130 are to be removed prior to the installation of flooring or preparation of the sub-floor for flooring. However, if flooring does not require adhesion to the sub-floor, and if no ill effects will result, the template 130 may remain in place under flooring installation. As shown in FIG. 5, to remove a portion 142 of the template 130, the template 130 is cut using a tool having a sharp blade—such as a utility knife or the like which are commonly used in construction—along wall base plates. The portion 142 is then lifted up, typically rolled or folded and removed.

In the exemplary embodiment, then, the method of constructing a building can comprise: generating a construction template for a building, the construction template comprising one or more sheets of a polymeric material, the one or more sheets having a full scale floor plan printed thereon for at least a portion of the building including markings representing construction elements, the markings being sized and positioned on the one or more sheets in full scale; installing the construction template on a subfloor of the building so that the markings on the construction template are positioned on the subfloor in the same location as the corresponding construction elements that the markings represent are desired to be constructed; and constructing the construction elements of the building directly on the construction template, using the construction template as a guide. The method can further include securing adjacent sheets together and/or incorporating construction revisions on the construction template.

Generating the construction template for the building can comprise creating one or more digital image files based on a set of construction drawings; and printing at least a portion of the one or more digital image files on at least one side of each sheet using an imaging device.

If the building under construction comprises more than one floor, the above process can be repeated for each floor and accompanying sub-floor. As such, one embodiment of the present invention can comprise a set of construction templates for constructing a multi-story building. The set includes a plurality of construction templates 130, each corresponding to a separate story of the multi-story building. As noted above, each construction template 130 can comprise a plurality of sheets 132 that together form a full size floor plan 122 of the corresponding story of the building, with each sheet 132 containing a full scale representation of a different portion of the floor plan 122 such that adjacent sheets 132 overlap when the sheets 132 are positioned to form the floor plan 122.

A method of construction can also be performed on the multi-story building, in which the acts of generating a construction template, installing the construction template, and constructing the construction elements can be separately performed for each story of the building using separate construction templates.

Although depicted in a specific order in the flow chart shown in FIG. 1, it is appreciated that many of the disclosed steps can be performed in a different order or omitted altogether. For example, the graphics adding step 108 can alternatively be performed during the drawing manipulation stage instead of after it. Furthermore, many of the steps can be performed or repeated in an iterative process. For example, a sample print can be performed in step 112 and if the builder is not satisfied, steps 100-112 can be repeated as many times as desired, in whole or in part, to produce the desired template.

As noted above, although the template 130 has been described herein as being formed of a plurality of long sheets 132 that are positioned side-by-side on the sub-floor, this is only exemplary. For example, for narrow sub-floors or where printer capabilities exist, template 130 can comprise a single sheet that requires no aligning with other sheets.

In an alternative embodiment, the template 130 can be used as a mockup so that a building owner or prospective buyer can view and perform a walk-through on the floor plan in full scale before construction. This allows any desired modifications to be made on the floor plan, thus saving time and money. In this embodiment, the template 130 is generated as described above and installed on the sub-floor at the project site or on a floor of a warehouse or other large surface in which a prospective buyer can perform the walk-through. The installation of the template 130 can be performed as described above. After installation of the template 130, the owner or prospective buyer is then allowed to perform the walk through and propose modifications accordingly. The modifications can either be inscribed directly on the template or a new template can be generated, depending on the amount and types of modifications required. The modified template can then be used for construction, as discussed above.

Alternative Terminology that may be used in the art:

| | |
|---|---|
| Full scale: | Full size, Life size, Actual size, |
| Plan(s): | Template, Pattern, Blueprint, Print, Drawing, Image, |
| | Shop Drawing, Scheme, Map, Plot, Working Drawing, |
| | Construction Drawing, |
| Building: | Structure, Edifice |
| Layout: | Organization, Set-up, Placement, Arrangement, Location |
| Mockup | Preview, Walk-through, Dry-run |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A construction template configured to allow a building to be constructed thereon, the construction template comprising:
a plurality of sheets, each sheet comprising:
a first side and an opposing second side, and
markings printed on at least one of the sides of the sheet, the markings comprising full scale representations of construction elements;
wherein each sheet contains a full scale representation of a different portion of a floor plan for at least a portion of a building such that adjacent sheets overlap to form the floor plan.

2. The construction template as recited in claim 1, wherein the markings represent items to be constructed on the ceiling.

3. The construction template as recited in claim 1, wherein the sheets include registration marks or grids that align between sheets when the sheets overlap to form the floor plan.

4. The construction template as recited in claim 1, wherein the plurality of sheets also form an apron with advertising printed thereon, the apron being positioned outside the representation of the floor plan.

5. The construction template as recited in claim 1, wherein the markings represent one or more of the following construction elements:
walls, windows, doors, cabinets, columns, heat registers, plumbing fixtures.

6. The construction template as recited in claim 1, wherein the markings further comprise representations of construction elements that are not in full scale.

7. The construction template as recited in claim 6, wherein the markings represent one or more of the following construction elements:
electrical outlets, lighting fixtures, telephone outlets, and network cable outlets.

8. The construction template as recited in claim 1, wherein each sheet comprises a polymeric material.

9. A set of construction templates for constructing a multi-story building, the set comprising:
a plurality of construction templates, each construction template corresponding to a separate story of the multi-story building, each construction template comprising:
a plurality of sheets that together form a full size floor plan of the corresponding story of the building, each sheet containing a full scale representation of a different portion of the floor plan such that adjacent sheets overlap when the sheets are positioned to form the floor plan.

10. A method of constructing a building, the method comprising:
generating a construction template for a building, the construction template comprising one or more sheets of a polymeric material, the one or more sheets having a full scale floor plan printed thereon for at least a portion of the building including markings representing construction elements, the markings being sized and positioned on the one or more sheets in full scale;
installing the construction template on a subfloor of the building so that the markings on the construction template are positioned on the subfloor in the same location as the corresponding construction elements that the markings represent are desired to be constructed; and
constructing the construction elements of the building directly on the construction template, using the construction template as a guide.

11. The method as recited in claim 10, wherein generating the construction template for the building comprises:
creating one or more digital image files based on a set of construction drawings; and
printing at least a portion of the one or more digital image files on at least one side of each sheet using an imaging device.

12. The method as recited in claim 10, wherein the construction template comprises a plurality of sheets, each sheet having a portion of the floor plan printed thereon, and wherein installing the construction template on the subfloor comprises:
positioning the sheets on the subfloor to form the full scale floor plan; and
securing the sheets to the subfloor.

13. The method as recited in claim 12, wherein positioning the sheets on the subfloor comprises overlapping adjacent sheets on the subfloor.

14. The method as recited in claim 13, wherein overlapping adjacent sheets on the subfloor comprises aligning registration marks or grids that are printed or formed on the adjacent sheets.

15. The method as recited in claim 13, further comprising securing adjacent sheets together.

16. The method as recited in claim 10, wherein installing the construction template on a subfloor comprises fastening the construction template to the subfloor with fasteners.

17. The method as recited in claim 10, wherein installing the construction template on the subfloor comprises cutting out portions of the construction template corresponding to construction elements that have been constructed on the subfloor prior to the installation of the construction template.

18. The method as recited in claim 10, further comprising incorporating construction revisions on the construction template after installation of the construction template on the subfloor by performing one or more of the following:
marking the construction template with a marker;
covering up a portion of the construction template; and
generating a new portion of the construction template that includes the construction revisions and installing the new portion over a corresponding portion of the original construction template.

19. The method as recited in claim 10, wherein the construction template includes an apron with printing thereon, and wherein installing the construction template on the subfloor comprises installing the construction template on the subfloor such that the apron overhangs an outside edge of the subfloor so that the printing is viewable from outside the building.

20. The method as recited in claim 10, wherein the building is multi-story building and the acts of generating a construction template, installing the construction template, and constructing the construction elements are separately performed for each story of the building using separate construction templates.
